(19) United States
(12) Patent Application Publication
(10) Pub. No.: US 2017/0092155 A1
(43) Pub. Date: Mar. 30, 2017

(54) Educational Kit for Practicing Electronic Circuit Design-II

(71) Applicant: Henry Hyunbo SHIM, Los Angeles, CA (US)

(72) Inventor: Henry Hyunbo SHIM, Los Angeles, CA (US)

(21) Appl. No.: 14/866,851

(22) Filed: Sep. 26, 2015

(51) Int. Cl. G09B 23/18

(52) U.S. Cl. CPC G09B 23/183

(57) ABSTRACT

An educational kit for teaching kids/beginners about designing electronic circuit is provided. The educational kit according to the current application comprises of; 1) a square hard board that is comprises of; a face board made of stiff non-conductive material, including but not limited to, plastic such as PVC (Poly vinyl chloride), wood, paper hard board, etc.; a brim made of the same material of the face board with 3 mm thickness and 2.5 cm width and a steel plate adhered to the back side of the square board with glue, 2) pluralities of various kinds of electronic components, such as resistor, capacitor, etc., which have wire type leads/terminals (5) for connection, 3) pluralities of small permanent magnets (4) of circular shape, 4) a part box (1-2) that holds the electronic components and the small permanent magnets, and 5) a separate manual (6) wherein various electronic circuits are printed. Pluralities of dents of circular shape and square shape are developed on the face board to receive magnets and electronic components, respectively. Another embodiment of the hard board is comprised of; a back board made of stiff non-conductive material of 3 mm thickness; a steel plate adhered on the back board; a paper face sheet (2′) whereon pluralities of square shape spaces (8′), which is surrounded by narrow non-conductive material, are developed throughout the paper face sheet (2′) and adhered on the steel plate; and a brim (1-3) made of plastic, such as PVC, PMMA (Poly-methyl methacrylate), and surrounding the paper face sheet (2′), with 3 mm height and 2.5 cm width.

### FIELD OF THE INVENTION

Current application related to an educational kit for practicing electronic circuit design for beginners, especially related to a circuit design practicing kit without soldering but use magnetic force.

### BACKGROUND OF THE INVENTION

In many instances, a circuit is hand soldered by a person assembling an electronic circuit. This is particularly true where electronic kits are provided for educational purposes or where a new circuit is being designed and tested. For example, a kit for a particular type of circuit, such as a radio, may be given to or otherwise obtained by a child to assemble for educational purposes. The kit will usually include a printed circuit board and the necessary electronic components to be connected by soldering to the printed circuit board to make the desired circuit. The soldering of the components is usually not an essential learning step to be performed by the child and soldering can be difficult and dangerous for a child. First, the person doing the soldering has to have a soldering iron. An inexperienced person can easily burn himself or herself with the soldering iron. Also, excessive heat can damage and destroy electronic components. Thus, if too much heat is applied to a component during soldering, the component can be destroyed. Further, if substitution of components is a part of the learning exercise in assembling and working with the circuit, or is part of designing and testing a new circuit, soldering the components to the printed circuit board is counterproductive in that a particular component may have to be un-soldered to disconnect it from the circuit to replace it with a substitute component.

On the other hand, various bread boarding devices are available for use in designing electronic circuits where the leads of electronic components can be inserted into connectors on a breadboard device, such bread boarding devices generally require special knowledge of the devices and how they work and are not generally used in merely assembling a particular desired circuit in an educational kit.

It is the purpose of the current application to provide an educational kit to set up a desired electronic circuit without soldering and change the configuration of the electronic circuit by just rearrange of the electronic components on a board.

### DESCRIPTION OF PRIOR ARTS

U.S. Pat. No. 3,038,139 to Bonanno illustrates an electrical contact socket and a socket for apparatus having magnetizable terminals requiring electrical actuation, in which the apparatus is held in the socket by magnetism and without any mechanical clamping means.

U.S. Pat. No. 3,175,304 to OCH, et al. illustrates an educational visual device for teaching electrical circuit theory, fundamentals, electronics, and the like.

U.S. Pat. No. 3,324,572 to ROBARGE illustrates an electrical instruction kit and connector for use therein.

U.S. Pat. No. 3,510,963 to ZBAR, et al. illustrates an apparatus for demonstrating the operation of electrical and electronic circuits and systems comprised of a chalk board of ferromagnetic material with power distribution bars disposed about the periphery of the chalk board and provided with pluralities of connection points consisting of drilling holes.

U.S. Pat. No. 3,845,573 to Kasamatsu illustrates an electrical circuit assembling apparatus for experimentation, allowing various electronic parts to be located on an insulating base plate, on which terminals are interconnected by means of leads, by making use of magnetic attraction, for which either a metal plate is used underneath the base plate, or block-shaped metal pieces, which latter can be above or below said base plate. For assemble the circuit, each end of the leads from electronic compartment should be soldered or screwed for connection.

U.S. Pat. No. 4,752,756 to Bartel illustrates an electrical system with at least one electric load unit being disconnectably arranged on a surface an electrical system with at least one electric load unit (E) magnetically attached to a surface (F) being provided with path conductors (L).

U.S. Pat. No. 6,449,167 to Seymour disclosed a method and system with a magnetically attractive breadboard and associated devices for constructing and testing electronic circuits. U.S. Pat. Nos. 7,758,349 and 7,611,357 to Han, et al. illustrated a printed circuit boards and breadboard devices having contact pads and magnetic component connectors where connection between the contact pads and the magnetic component connectors are made by magnetic force. Either the contact pad or the magnetic component connector will be magnetic and the other will be made of a material to which a magnet will be attracted.

U.S. Patent Application 20030043554 by Seymour discloses a method and system with a magnetically attractive breadboard and associated devices for constructing and testing electronic circuits. The breadboard can comprise a single or multi-layer circuit board with metallic foil conductors that can be connected to magnetically attractive pads. Electrical contacts between the pads and foil conductors can be made by wrapping the foil over an edge of insulating material.

U.S. Patent Application 20040229489 by Lu illustrates a circuit-toy assembly kit includes a plurality of connector units each including a supporting frame, two terminal fasteners spacedly affixed to the supporting frame, and a terminal circuit electrically connecting with the terminal fasteners.

U.S. Patent Application 20050036264 by Aguilar illustrates an assembly structures that are characterized to allow electronic components quick, safe, easy to modify (manipulate by hands without tools), and visually intuitive (topographic) three-dimensional construction of circuits.

None of the prior art illustrates an educational kit for practicing electronic circuit design for beginners/kids so simple and easy to assemble an electronic circuit and to change the configuration as shown in the current application.

### SUMMARY OF THE INVENTION

In many instances, a circuit is hand soldered by a person assembling an electronic circuit. For example, a kit for a particular type of circuit, such as a radio, may be given to or otherwise obtained by a child to assemble for educational purposes. The kit will usually include a printed board and the necessary electronic components to be connected by soldering to the board to make the desired circuit. The soldering of the components is usually not an essential learning step to be performed by the child and, soldering can be difficult and dangerous for a child. First, the person doing the soldering has to have a soldering iron. An inexperienced person can easily burn himself or herself with the soldering iron. Also, excessive heat can damage and destroy electronic components. Thus, if too much heat is applied to a component during soldering, the component can be destroyed. Further, if substitution of components is a part of the learning exercise in assembling and working with the circuit, or is part of designing and testing a new circuit, soldering the components to the printed circuit board is not productive in that a specific component may have to be un-soldered to dis-connect it from the circuit to replace it with a substitute component. Various bread boarding devices are available for use in designing electronic circuits where the leads of electronic components can be inserted into connectors on a breadboard device, such bread boarding devices generally require special knowledge of the devices and how they work and are not generally used in merely assembling a particular desired circuit in an educational kit. It is the purpose of the current application to provide an educational kit to set up a desired electronic circuit without soldering and change the configuration of the electronic circuit by just re-arrange of the electronic components on a board. An educational kit for teaching beginners about designing electronic circuit is provided. The educational kit of the current application comprises of; 1) a square hard board comprised of a dented face board made of stiff non-conductive material; a steel plate adhered to the back side of the square board with glue; and a brim surrounding the dented board, 2) pluralities of various kinds of electronic components which have wire type leads/terminals for connection, 3) pluralities of small permanent magnets of circular shape, 4) a part box that holds the electronic components and the small permanent magnets, and 5) a separate manual wherein various electronic circuits are printed thereon. Pluralities of dents of circular shape and square shape are developed on the face board to receive magnets and electronic components, respectively. Another embodiment of the hard board has a face board whereon pluralities of square spaces are developed isolated by surrounding narrow non-conductive material.

### BRIEF DESCRIPTION OF DRAWINGS

FIG. 1 is a perspective view of an educational kit for practicing electronic circuit design beginners/kids according to the current application.

FIG. 2 is an example of an amplifier electronic circuit printed on manual.

FIG. 3 is a schematic drawing of covering copper lead/terminals with narrow diameter steel tube.

FIG. 4 is a cross sectional view of the section A-A′ in the FIG. 1 showing how a resistance is hold in place by the magnetic force between steel plate, circular shape permanent magnet and steel tube covered leads/terminals.

FIG. 5 is a front view of another embodiment of the hard board of the educational kit for practicing electronic circuit design for beginners/kids according to the current application.

FIG. 6 is a cross sectional view of the embodiment of the hard board of the educational kit for practicing electronic circuit design for beginners according to the current invention along the section B-B′ in the FIG. 5.

### DETAILED DESCRIPTION OF THE PREFERRED EMBODIMENTS

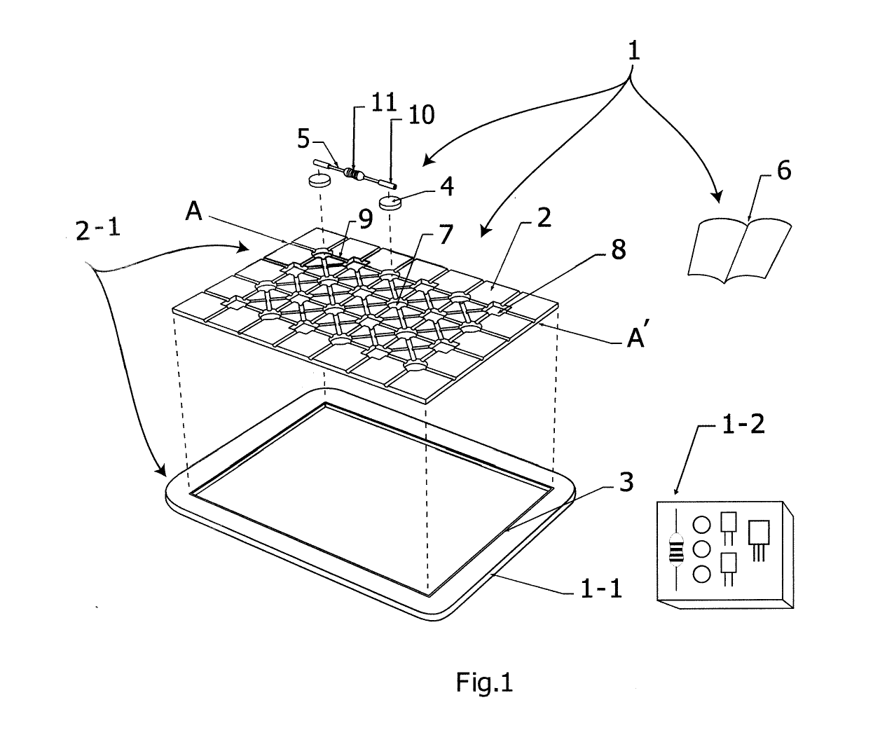

FIG. 1 is a perspective view of an educational kit (1) for practicing electronic circuit design for beginners/kids. The educational kit according to the current application comprises of; 1) a square hard board (2-1) comprises of; a face board (2) made of stiff non-conductive material, including but not limited to, plastic such as PVC (Poly vinyl chloride), wood, paper hard board, etc.; a brim (1-1) made of the same material of the face board (2) with 3 mm thickness and 2.5 cm width and a steel plate (3) adhered to the back side of the square board with glue, 2) pluralities of various kinds of electronic components, such as resistor, capacitor, etc., which have wire type leads/terminals (5) for connection, 3) pluralities of small permanent magnets (4) of circular shape, 4) a part box (1-2) that holds the electronic components and the small permanent magnets, and 5) a separate manual (6) wherein various electronic circuits are printed. The square hard board (2-1) may be prepared by injection molding of plastic, which includes the face board (2) and brim (1-1), followed by adhering the steel plate (3) at the bottom of the face board (2-1).

Pluralities of dents of circular shape (7) and square shape (8) are developed on the face board(2) to receive magnets and electronic components, respectively. Each dents are spaced with same intervals and connected each other via straight grooves (9). Circular shape dents (7) receive circular permanent magnets (4) and square dents receive electronic components (15),(16). The circular shape dents (7) and square shape dents (8) may be holes that penetrate the square hard board (2) to the other side thereof. In that case, a thin non-conductive material such as paper sheet or plastic sheet may be inserted between the face board (2) and the steel plate (3). Brim (1-1) of the face board (2) is surrounded with the same stiff non-conductive material as the hard board (2-1) with 3 mm height and 2.5 cm width. The steel plate (3) may be adhered to the rear surface of the face board (2) with glue. Several electronic circuits are printed on a separate manual (6).

The educational kit according to the current application is used as following example.

When a user want to set up an electronic circuit, open the manual and select a circuit desired.

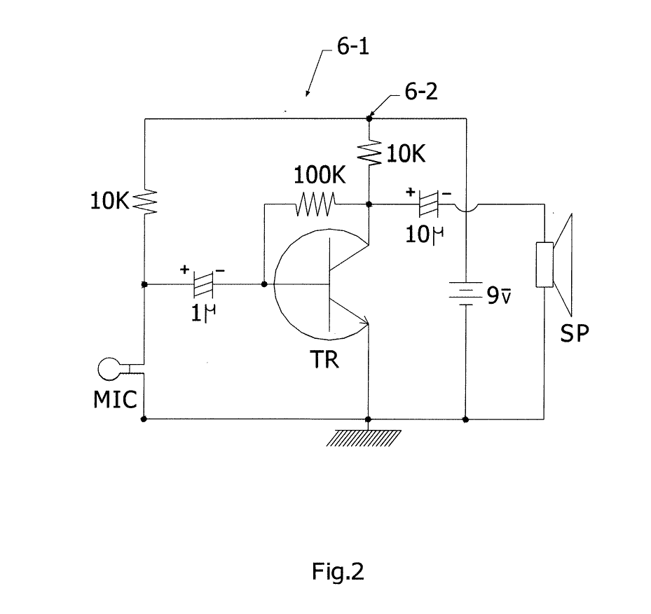

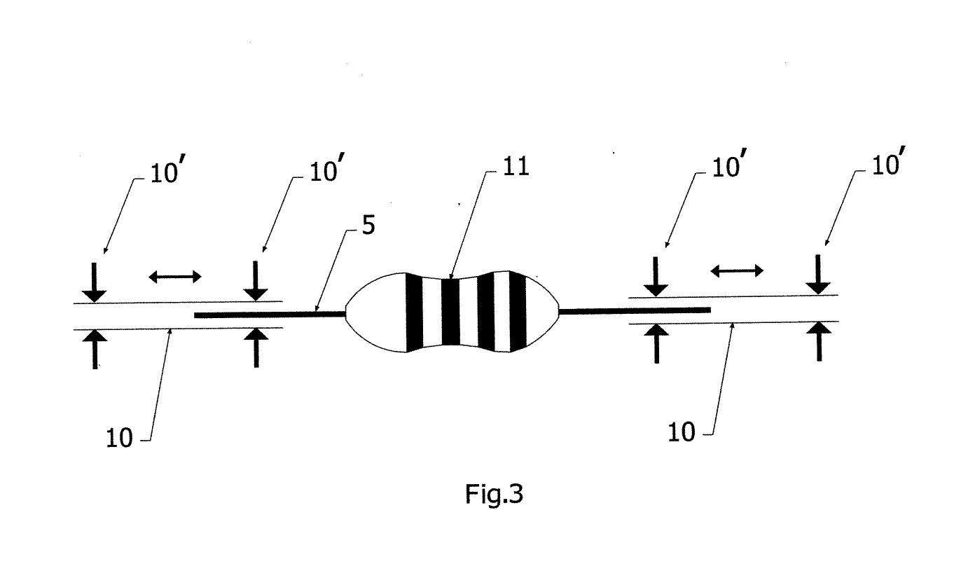

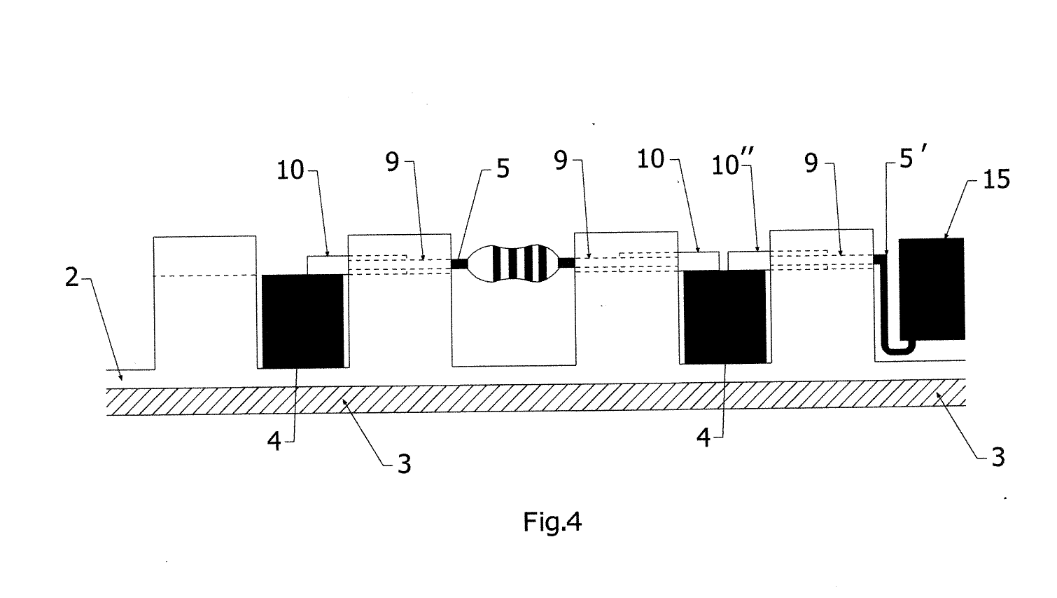

FIG. 2 is an example of electronic circuit (6-1) of an amplifier printed on the manual (6). The connection points (6-2) on the manual (6) indicate small circular permanent magnets (4) on the face board (2). In the current invention these points (6-2) are small permanent magnets (4) whereon the leads/terminals of (5) each electronic components are connected by the magnetic force of the small permanent magnets (4). Insert permanent circular magnets (4) to the circular dents (7) according to the electronic circuit (6-1) printed on the manual (6). Put electronic components on the square dents (8) according to the manual. All of the square dents (8) are neighboring to the circular dents (7). Put the leads/terminals (5) of the electronic components (resistor, capacitor, etc.) on the circular permanents magnet. If the leads/terminals (5) of the electric components are made of copper wires, insert the leads/terminals (5) into small diameter steel tubes (10) and clamp (10′) both ends of the steel tube (10) as shown in the FIG. 3 to render magnetic property to the leads/terminals (5). Length of the leads/terminals can be adjusted by moving the steel tube (10) outer-ward and clamp or cut out of the clamped tip. The steel tube (10) covered leads/terminals (5) are partly inserted into the straight grooves (9). Magnetic properties may also be rendered to the end of the leads/terminals by connecting small steel washer or twisting steel wire to the end of the leads/terminals. This method is much easier than clamping and cutting method to adjust the length of the leads/terminals. FIG. 4 is a cross sectional view of the section A-A′ in the FIG. 1 showing how a resistor (11) is hold in place by the magnetic force between steel plate (3), circular shape permanent magnet (4) and steel tube (10) covered or metal washer connected leads/terminals (5). Magnetic force between the steel tube (10) covered leads/terminals (5), circular permanent magnets (4) and the metal plate (3) below the non-conductive face board (2) hold the components of the selected electronic circuit in place as shown in the FIG. 4. The circular permanent magnets (4) are shared by another steel tube (10″) covered leads/terminals (5′) from another electronic components such as capacitor (15). Connecting power source such as battery to power inlet will make the electronic circuit work because the circular magnets (4) are conductive to electrical current. After one experiment is done, separate the electronic components (15),(16) and permanent magnets (4) from the circular shape dents (7) and square shape dents (8). No soldering step is involved in assembling step of the electronic circuit and disassembling step. Next test of another electronic circuit can be started immediately without any additional preparation.

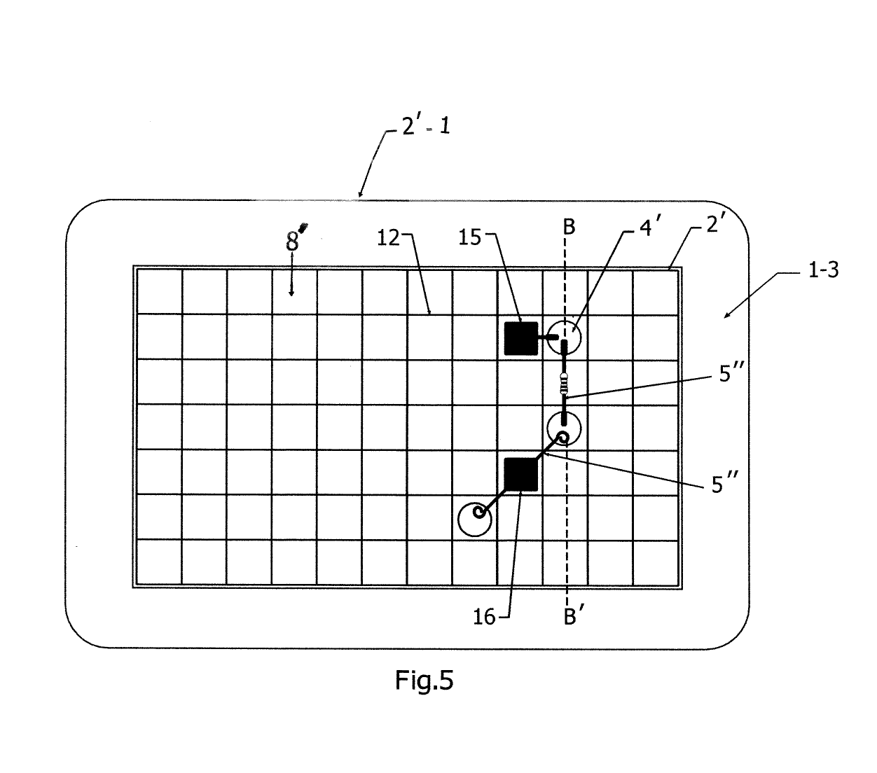

FIG. 5 is a front view of another embodiment of the hard board (2′-1) of the educational kit for practicing electronic circuit design for beginners. The another embodiment of the educational kit is comprised of; 1) a hard board (2′-1), which is comprised of; a back board made of stiff non-conductive material of 3 mm thickness; a steel plate adhered on the plastic plate (not shown in the FIG. 5); a paper face sheet (2′) whereon pluralities of square shape spaces (8′), which is surrounded by narrow non-conductive material, are developed throughout the paper face sheet (2′) and adhered on the steel plate; and a brim (1-3) made of plastic, including but not limited to, PVC, PMMA (Poly-methyl methacrylate), wood, paper hard board, etc. and surrounding the paper face sheet (2′), with 3 mm height and 2.5 cm width, 2) pluralities of small round permanent magnets (4′), 3) pluralities of electronic components, 4) a part box (1-2) that holds the electronic components (15), (16) and the small permanent magnets (4), and 5) a separate manual (6) wherein various electronic circuits are printed. The brim (1-3) may be decorated with many drawings such as electronic parts. The another embodiment of the hard board (2′-1) may be prepared by injection molding of plastic, which includes the back board and the brim (1-3) followed by adhering the metal plate to the back board and adhering the paper face sheet (2′) on the metal plate.

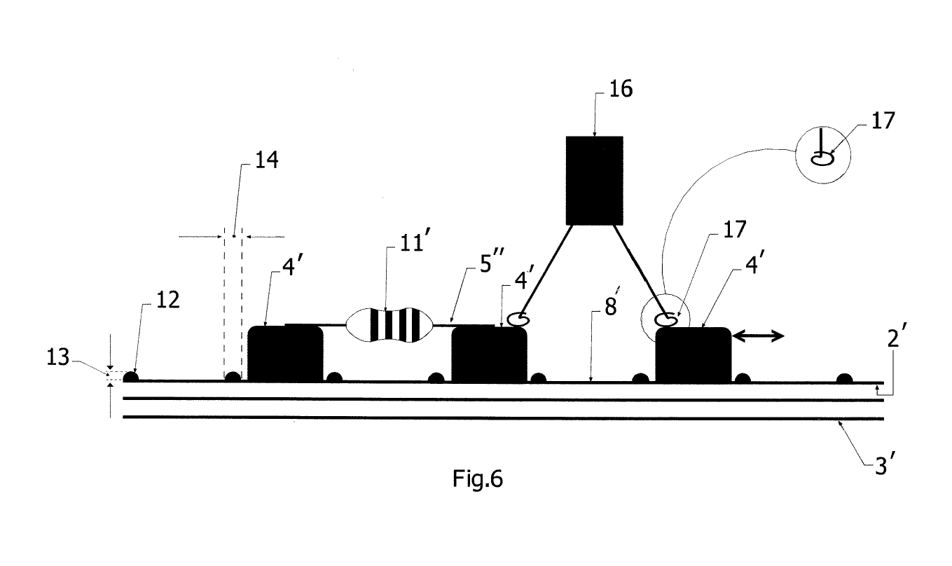

FIG. 6 is a cross sectional view of the another embodiment of the hard board (2′-1) of the educational kit for practicing electronic circuit design for beginners according to the current invention along the section B-B′ in the FIG. 5. The square spaces (8′) are formed by small humps (12) of non-conductive material, whose height (13) is less than 0.3 mm and width (14) is less than 0.3 mm, connected in square shape to avoid short circuit by direct contact of circular shape permanent magnets (4′) and for easy movement to a desired position just by sliding the circular shape permanent magnets (4′). On the hard board (2′-1), circular shape permanent magnets (4′) and electronic components (15), (16) are located on the neighboring square spaces (8′). Each electronic components are connected with other electronic component via the steel leads/ terminals (5″), which contact with the circular shape permanent magnets (4′). The magnets (4′) and steel leads/terminals (5″) are hold in place in the square space (8′) by the magnetic force that attracts the steel leads/terminals (5″) and steel plate (3′) below the paper face sheet (2′). The steel plate (3′) may be attached to the hard board via glue. Some electronic component's (16) and resistors (11′) can be placed in any position from up ward to horizontal to the hard board (2′-1) between magnets (4′) by folding the end of the leads in a flat shape (17) or tie a small metal washer or metal wire to the end of leads/terminals (5″). Electricity from the power source, such as battery, flows through the leads/terminals (5″) because all the components and the magnets (4′) are comprised of conductive materials. After one experiment is done, separate power source and separate electronic components (15), (16) from circular magnets (4′). And move the circular magnets (4′) to a new position by sliding the magnets (4′) along the surface of the paper face sheet (2′). And put electronic components (15), (16) up-ward by connecting the leads/terminals (5″) on the circular magnets (4′) positioned on a new positions according to a new circuit from the manual (6). No soldering step is involved in assembling step of the electronic circuit and disassembling step. Next test of another electronic circuit can be started immediately without any additional preparation. As described above the educational kit for practicing electronic circuit design for beginners/kids according to the current application enables a user an easy and clean practice of designing a new electronic circuit and enables a beginner, including kids, a safe and clean experiment to understand principle of electronic circuit.

What is claimed is:

1. An educational kit for practicing electronic circuit design for beginners comprises of;
a square hard board comprised of;
a face board made of stiff non-conductive material, wherein pluralities of dents of circular shape and square shape are developed on front side thereof to receive magnets and electronic components, respectively;
a brim made of stiff non-conductive material of 3 mm thickness and 2.5 cm width; and
a steel plate adhered to the back side of the square board with glue;
pluralities of various kinds of electronic components, which have wire type leads and terminals for connection;
pluralities of small permanent magnets of circular shape;
a part box that holds the electronic components and the small permanent magnets; and
a separate manual wherein various electronic circuits are printed.

2. An educational kit for practicing electronic circuit design for beginners of claim 1, wherein the stiff non-conductive material is PVC (Poly vinylchloride).

3. An educational kit for practicing electronic circuit design for beginners of claim 1, wherein the square hard board is prepared by injection molding of plastic, which includes the face board and brim, and adhere the steel plate at the bottom of the face board with glue.

4. An educational kit for practicing electronic circuit design for beginners of claim 1, wherein the stiff non-conductive material is wood.

5. An educational kit for practicing electronic circuit design for beginners of claim 1, wherein the stiff non-conductive material is paper hard board.

6. An educational kit for practicing electronic circuit design for beginners of claim 1, wherein the stiff non-conductive material is PMMA (Poly-methylmethachrylate).

7. An educational kit for practicing electronic circuit design for beginners of claim 1, wherein each dents are spaced with same intervals and connected each other via straight grooves.

8. An educational kit for practicing electronic circuit design for beginners of claim 1, wherein each electronic components are connected by the small permanent magnets through their terminals and leads.

9. An educational kit for practicing electronic circuit design for beginners of claim 1, wherein both of the terminals and leads of the electronic components are covered with small diameter steel tube and clamped, when the terminals and leads are made of copper wires, to render magnetic property to the terminals and leads.

10. An educational kit for practicing electronic circuit design for beginners of claim 1, wherein both of the terminals and leads of the electronic components are connected with small steel washer, when the terminals and leads are made of copper wires, to render magnetic property to the terminals and leads.

11. An educational kit for practicing electronic circuit design for beginners comprises of;
a hard board, which is comprised of;
a back board made of stiff non-conductive material of 3 mm thickness;
a steel plate adhered on the plastic plate;
a paper face sheet whereon pluralities of square shape spaces, which is surrounded by narrow non-conductive material, are developed throughout the front surface of the paper sheet which is adhered on the steel plate; and
a brim made of PMMA (Poly-methyl methacrylate) and surrounding the paper face sheet with 3 mm height and 2.5 cm width;
pluralities of various kinds of electronic components, which have wire type steel leads and terminals for connection;
pluralities of small permanent magnets of circular shape;
a part box that holds the electronic components and the small permanent magnets; and
a separate manual wherein various electronic circuits are printed.

12. An educational kit for practicing electronic circuit design for beginners of the claim 11, wherein square spaces are formed by small humps of non-conductive material, whose height is 0.1 mm and width is 0.1 mm, connected square shape to avoid short circuit by direct contact of circular shape permanent magnets and for easy movement to a desired position just by sliding the circular shape permanent magnets.

13. An educational kit for practicing electronic circuit design for beginners of claim 11, wherein the stiff non-conductive material is PVC (Poly vinylchloride).

14. An educational kit for practicing electronic circuit design for beginners of claim 11, wherein the hard board is prepared by injection molding of plastic, which includes the back board and the brim followed by adhering the metal plate on the back board and adhering the paper face sheet on the metal plate.

15. An educational kit for practicing electronic circuit design for beginners of claim 11, wherein the stiff non-conductive material is paper hard board.

16. An educational kit for practicing electronic circuit design for beginners of claim 11, wherein the stiff non-conductive material is wood.

17. An educational kit for practicing electronic circuit design for beginners of claim 11, wherein the stiff non-conductive material is PMMA (Poly-methylmethachrylate).

18. An educational kit for practicing electronic circuit design for beginners of claim 11, wherein each electronic components are connected by the small permanent magnets through their terminals and leads.

19. An educational kit for practicing electronic circuit design for beginners of claim 11, wherein both of the terminals and leads of the electronic components are connected with small steel washer, when the terminals and leads are made of copper wires, to render magnetic property to the terminals and leads.

20. An educational kit for practicing electronic circuit design for beginners of claim 11, wherein both of the terminals and leads of the electronic components are covered with small diameter steel tube and clamped, when the terminals and leads are made of copper wires, to render magnetic property to the terminals and leads.
